(19) United States
(12) Patent Application Publication
(10) Pub. No.: US 2008/0217030 A1
(43) Pub. Date: Sep. 11, 2008

(54) Fireproof Blanket Which is Used to Protect People, Furniture and Property Against Fire

(76) Inventors: Ricardo Grossman Goldeschelder, Edo de (MX); Samuel Ricardo Fis Menache, Miguel Hidalgo (MX)

Correspondence Address: COOK ALEX LTD, SUITE 2850, 200 WEST ADAMS STREET, CHICAGO, IL, 60606, US

(21) Appl. No.: 11/916,977

(22) PCT Filed: Jun. 10, 2004
(86) PCT No.: PCT/MX05/00045

§ 371 Date: Dec. 11, 2007

(30) Foreign Application Priority Data
Jun. 9, 2005 (MX) PA/A/2005/006127

(51) Int. Cl. A62C 8/06; D04H 13/00

(52) U.S. Cl. 169/50; 169/48; 442/414

(57) ABSTRACT

The invention relates to a fireproof blanket which is used to protect people, furniture and property against fire. The inventive blanket is characterized in that the raw materials used comprise OPF which have been molecularly stabilized by means of thermal processing and PES. The process consists in mixing the two fibers in order to obtain the desired degree of fireproof performance and suitable tactile qualities such that it can be used for any application and can be brought into contact with the skin without causing any type of allergic reaction owing to the inert nature thereof. The aforementioned mixture is reinforced mechanically in order to provide the blanket with the transverse and longitudinal resistance properties that are required for same to be used for the following applications, namely: any type of fire-protective clothing and the applications thereof; fireproof cushioning layer for furniture, bed linen, mattresses, seats and backrests in motor vehicles, trains and aircraft; fire blankets; supports for wallpaper and fire curtains; fire protective under-carpet padding; fire protective thermal blankets; maintenance and construction work on sites with a high-, medium-o low-risk of fire; and fire protective blankets that can be used to protect any item, since it can be produced with any length or thickness.

### FIELD OF THE INVENTION

Mixture of oxidized polyacrylonitrile fibers (OPF) which are molecularly stabilized by means of thermal processing and polyethylene terephthalate fibers (PES) which produce a degree of fireproofing and suitable tactile qualities and anti-allergic such that it can be used for any application against fire both in people as well as in furniture and properties.

### BACKGROUND OF THE INVENTION

There are many needs for coverings that are fireproof. At times such coverings are referred to as fireproof blankets. Such coverings or blankets are intended for protection against fire of furniture, properties and people and/or for preventing or reducing damage to such objects, that due to their location, or people due to their profession, work within a determined environment, are exposed to potential risk of fire.

Patent Application MX 91000150, and Patents JP 9059857, JP 2002052307, JP 2001279073, JP 2003183509, JP 2004300601, and U.S. Pat. No. 6,498,227 B1, are known for referring to a process, additives or coatings for retarding fires. In none of the cases is the clothing composition mentioned as providing the fire retarding properties Some of those prior approaches utilize both carbon black as well as red phosphorus but never as part of the product out of which the clothing is made. Likewise, Patent JP 8074141 describes a fire-retardant product, and utilizes compounds other than the fibers to achieve fire-retardant properties but not fireproof properties of the present invention.

There are previous documents describing fibers such as Application 2203006, PA/a/1996/006745, Publication No. 166068 and Patent JP 2003268651. These are different from the present invention since they show the disadvantage of not having adequate flexibility, and they have an aspect rough to the touch.

Patent Application WO2004/031465 A1, WO 0242534, U.S. Pat. No. 6,812,171 B2 and JP2003239163 specify non-tissue that is composed of two layers. Layers include an acrylic fiber with flame resistance with its characteristics and a non-woven carbon fiber clothing with its characteristics being produced by applying a carbonization treatment. The present invention includes a process of providing the fiber mixture, and not a carbonization treatment thereof.

Patent Application WO 99/37852, MX 9606745 and Patent JP 2004270095 describe a treatment for achieving flame delay; however, unlike what is proposed in the present invention which is not a treatment on fibers but a combination thereof for obtaining an end product, which is fireproof. Patent Application EP 1 466 940 A1 and Patent Application US 2004/0241440 A1 describe a carbon nano-fiber compound and elastomers in dispersion, to provide a composition resulting from a constitution different from the present invention.

Application JP2002129456 is about a process for making a flame-retardant cushion which does not lose resiliency throughout time, and this is said to be achieved by placing the carbon fibers in different directions. This is different from the present invention, which comprises a mixture of two types of fibers passed through a mechanical process for forming a fireproof non-woven cloth.

### SUMMARY OF THE INVENTION

Some of these prior documents show a fiber having adequate characteristics of flexibility; however, these are obtained by means of a process which is different from the present invention in that the process of the present invention consists in mixing two fibers by specified weights. The fibers are oxidized polyacrylonitrile fibers (“OPF”) and polyethylene terephthalate fibers (“PES”). Included is varying the percentages of the two fibers according to the final application within a range of 50/50 up to 90/10 being the first percentage of the OPF fiber and the second PES.

The fibers are mixed through a system of barbed rolls named loaders/weighs which homogenize the dosed quantity of each component. From there it goes through an air system which mixes again the two components in order to achieve a greater homogeneity, referred to as fine opener, leaving a bicolor mixture. This web goes through a pre-punched mechanically assembled system, punching in both sides which tridimensionally entwines the fibers giving them longitudinal and transversel resistance having as a consequence a non-woven “cloth” with predetermined weight by squared meter. It is rolled and borders are cut widthwise when it is desired to obtain rolls of a specific length and exact width. It goes through a calendaring system with pressure and temperature for giving a homogeneous and calibrated thickness throughout the entire cloth length, this being the product to be cut in the dimensions necessary for the intended use.

Products made according to the previously mentioned prior documents are made according to a completely different process.

This mixture of two fibers is reinforced mechanically in order to provide the blanket with the transverse and longitudinal resistance properties that are required for same to be used for the following applications, namely: any type of fire-protective clothing and the applications thereof; fireproof cushioning layer for furniture, bed linen, mattresses, seats and backrests in motor vehicles, trains and aircraft; fire blankets to go through fire; fire-protective cover sheeting for any furniture, property or people; support for wallpaper and fire curtains; fire-protective under-carpet padding; and fire-protective thermal blankets.

### DETAILED DESCRIPTION OF THE INVENTION

The invention comprises, mixing the two fibers with specified weights, varying the percentages of the two fibers in accordance to the final application intended for a specific use. The ratio of the two fibers are within a range of 50/50 up to 90/10 the first number being the percentage of the OPF fiber and the second number being the percentage of PES. Thus, the OPF is at between about 50 and about 90 weight percent, and the PES is at between about 50 and about 10 weight percent. These fibers are mixed through a system of barbed rolls named loaders/weighs which homogenize the dosed quantity of each component. From there it goes through an air system which again mixes the two components in order to achieve a greater homogeneity, named fine opener, leaving a bicolor mixture. From there it goes to a carding system, named high-production carding prepared for handling fine fibers, which forms a gray color web by the exact mixture of the two fibers.

This web goes through a pre-punched mechanically assembled system, punching in both sides which tridimensionally entwine the fibers giving them longitudinal and transversel resistance having as a consequence a non-woven “cloth” with predetermined weight by squared meter. It is rolled, and borders are cut widthwise when wishing to obtain rolls of a specific length and exact width. It goes through a calendaring system with pressure and temperature for giving a homogeneous and calibrated thickness throughout the entire cloth length, this being the product to be cut in the necessary dimensions.

The preferred embodiments of the fireproof blanket are in a presentation in such manner that the invention may cover any type of object in order to prevent it from burning. At the same time, products according to the invention can be used for putting out small fires just by covering the fire with a blanket according to the invention.

On the other hand, the invention can be used for people who are within a property that is on fire. They can just cover themselves with the same and go through the fire with no risk of burning themselves.

On the other hand, the invention can be used for clothing or blanket construction for uses against fires for those people who are at fire risks such as auto racing drivers or test pilots.

Also the products of the invention can be used in the building of furniture, floor coverings, wall coverings, and roof coverings for preventing fires. Other uses include for cushioning furniture, bed linen, and for cushions, seats and backrests in motor vehicles, trains and aircraft. Covers with the blanket material of the invention can be for preventing furniture from being burned. The invention can be used as a fire-protective blanket for protecting any type of article since it can be produced with any length and thickness. Further uses include support for wallpaper and fire curtains; fire-protective under-carpet padding; fire-protective thermal blankets; fire-protective blankets that can be used to go through fires at hotels, prisons, trains, airplanes, spacecraft, trains, ships. Applications include clothing for car pilots, airplane pilots, train drivers; clothing or blankets for people who work with fire such as at steel factories, applications using electric welding, grinding, cutting with torches, or as protection for stopping or developing sparks as protection from, hot washers, or for obstructing flashes.

The present invention provides blankets or fabric sheeting or material that exhibits adequate flexibility for these types of products or end uses. Also, such blanket, sheeting or material is not rough to the touch. In addition, these blankets, sheetings or materials are not only fire-resistant but also are considered to be fire-proof.

### EXAMPLE

The blanket made according to the present invention can be exposed to fire directly at temperatures greater than 1000° C. for a period of time of 15 seconds without being burned nor producing heat.

1. A fireproof blanket for protecting people, furniture and properties against fire, comprising a sheeting made of from a range of about 50% to about 90% by weight of oxidized polyacrylonitrile fibers (OPF) and of from a range of about 50% to about 10% by weight of polyethylene fibers (PES) based on the total weight of the sheeting.

2. The blanket according to claim 1 wherein the sheeting is made from raw materials of PES and of OPF which is molecularly stabilized through a thermal process.

3. The fireproof blanket according to claim 1 wherein said sheeting can be of different thicknesses and/or lengths varying in accordance with the desired application.

4. A process for obtaining the fireproof blanket of claim 1 comprising the following steps: mixing said OPF and PES fibers by specified weights, varying the percentages of said fibers in accordance with the final application within said ranges; mixing same through a system of barbed rolls named loaders/weighs which homogenize the dosed quantity of each component: passing same through an air system which mixes again said two fiber components in order to achieve a greater homogeneity named fine opener, leaving a bicolor mixture: passing same to a carding system named high production carding prepared for handling fine fibers which forms a gray color web by the exact mixture of said two fibers; passing said web through a pre-punched mechanically assembled system, punching in both sides which tridimensionally entwine the fibers giving them longitudinal and transverse resistance having as a consequence a non-woven “cloth” with predetermined weight by squared meter; rolling same and cutting borders widthwise in order to obtain rolls of a specific length and exact width; and calendaring same with pressure and temperature for giving a homogeneous and calibrated thickness throughout the entire cloth length, this being the product to be cut in the necessary dimensions.

5. Uses of the blanket of claim 1, comprising to make all types of clothing against fire and its applications or as fireproof cushioning layer for furniture, bed linen, mattresses, seats and backrests in motor vehicles, trains and aircraft, or as fire blankets or as support for wallpaper and fire curtain or as fire-protective under-carpet padding or fire-protective thermal blanket.

6. Uses according to claim 5 wherein the protective blankets are for going through fires in hotels, prisons, trains, airplanes, spacecraft, ships, automobiles or as clothing for car pilots, plane pilots, train drivers or as clothing or cover for people who work with fire such as steel factories, application of electric welding, grinding, cuts with torches or as protection for stopping or having sparks, hot washers, obstruct flashes or as cover for furniture in order to prevent them from burning or for pipes or ducts which require protection against fire according to the applicable building standards, as protective blanket against fires for protecting any article, furniture or property, since it can be made of any length and thickness.

7. The blanket according to claim 2 wherein said sheeting can be of different thicknesses and/or lengths varying in accordance with the desired application.

8. Uses of the blanket of claim 2, comprising: to make all types of clothing against fire and its applications or as fireproof cushioning layer for furniture, bed linen, mattresses, seats and backrests in motor vehicles, trains and aircraft, or as fire blankets or as support for wallpaper and fire curtain or as fire-protective under-carpet padding or fire-protective thermal blanket.

9. Uses according to claim 8 wherein the protective blankets are for going through fires in hotels, prisons, trains, airplanes, spacecraft, ships, automobiles or as clothing for car pilots, plane pilots, train drivers or as clothing or cover for people who work with fire such as steel factories, application of electric welding, grinding, cuts with torches or as protection for stopping or having sparks, hot washers, obstruct flashes or as cover for furniture in order to prevent them from burning or for pipes or ducts which require protection against fire according to the applicable building standards, as protective blanket against fires for protecting any article, furniture or property, since it can be made of any length and thickness.

10. Uses of the blanket of claim 3, comprising: to make all types of clothing against fire and its applications or as fireproof cushioning layer for furniture, bed linen, mattresses, seats and backrests in motor vehicles, trains and aircraft, or as fire blankets or as support for wallpaper and fire curtain or as fire-protective under-carpet padding or fire-protective thermal blanket.

11. Uses according to claim 10 wherein the protective blankets are for going through fires in hotels, prisons, trains, airplanes, spacecraft, ships, automobiles or as clothing for car pilots, plane pilots, train drivers or as clothing or cover for people who work with fire such as steel factories, application of electric welding, grinding, cuts with torches as protection for stopping or having sparks, hot washers, obstruct flashes or as cover for furniture in order to prevent them from burning or for pipes or ducts which require protection against fire according to the applicable building standards, as protective blanket against fires for protecting any article, furniture or property, since it can be made of any length and thickness.
